(19) United States
(12) Patent Application Publication
(10) Pub. No.: US 2013/0328772 A1
(43) Pub. Date: Dec. 12, 2013

(54) Handheld Pointing Device

(71) Applicant: PIXART IMAGING INC., Hsinchu City (TW)

(72) Inventors: Han-Ping CHENG, HSINCHU City (TW); Chao-Chien HUANG, HSINCHU City (TW); Chia-Cheun LIANG, HSINCHU City (TW)

(73) Assignee: PIXART IMAGING INC., HSINCHU City (TW)

(21) Appl. No.: 13/771,072

(22) Filed: Feb. 19, 2013

(30) Foreign Application Priority Data
Jun. 7, 2012 (TW) 101120524

(51) Int. Cl. G06F 3/033

(52) U.S. Cl. CPC G06F 3/033
USPC 345/158

(57) ABSTRACT

A handheld pointing device includes a main body, an image sensing module, an acceleration sensing module and a processing circuit. The image sensing module is disposed in the main body and configured to capture an image comprising at least one reference light source and accordingly generate an optical sensing signal. The acceleration sensing module is disposed in the main body and configured to sense an acceleration value in each one of two dimensions; wherein the acceleration sensing module outputs an acceleration sensing signal if an absolute value of the summation of the two acceleration values in two dimensions is located within a predetermined acceleration range. The processing circuit is configured to receive the optical sensing signal and the acceleration sensing signal and accordingly generate an output signal.

### TECHNICAL FIELD

The present invention relates to a pointing positioning field, and more particularly to a handheld pointing device.

### BACKGROUND

Handheld pointing device generally is adapted to use with a host, a display apparatus and two reference light sources. In the current technology, handheld pointing device uses a built-in image sensing module configured to sense the two reference light sources located near a display screen of the display apparatus so as to capture an image containing the two reference light sources. The handheld pointing device, after obtaining the captured image containing the two reference light sources, then calculates the coordinate positions of the two reference light sources in the captured image and transmit the calculated coordinate positions to the host; thus, the host can control an object (for example, a cursor) on an image shown by the display apparatus.

However, when a user holds the handheld pointing device and rotates his/her wrist 180 degrees, the image captured by image sensing module is correspondingly rotated 180 degrees, as illustrated in FIGS. 1, 2 and 3. FIG. 1 is a schematic view illustrating a handheld pointing device rotating with a rotation of a user's wrist; FIG. 2 is a schematic view of an exemplary captured image before the handheld pointing device being rotated; and FIG. 3 is a schematic view of the exemplary captured image after the handheld pointing device being rotated 180 degrees. In FIGS. 2, 3, the sub-images 202, 204 are obtained from the two reference light sources, respectively. As illustrated in FIG. 1, when a user holds the handheld pointing device 100 along an axis direction of a main body 102 thereof (e.g., the long edge of the main body 102) and rotates his/her wrist 180 degrees, the image captured by the image sensing module is converted from the image shown in FIG. 2 to the image shown in FIG. 3. As illustrated in FIGS. 2, 3, the positions of the two sub-images 202, 204 in the captured image are upside down and left-right reversal if the handheld pointing device 100 is rotated 180 degrees.

According to the aforementioned description, it is understood that the handheld pointing device 100 still points to the same direction while the user rotates his/her wrist 180 degrees; however, meanwhile the calculation of the positions of the two reference light sources performed by the handheld pointing device 100 is based on the two upside down and left-right reversal sub-images 202, 204 shown in FIG. 3. Thus, errors may occur if the host controls an object (for example, a cursor) on an image shown by the display apparatus based on the coordinate position calculated from the handheld pointing device 100.

### SUMMARY OF EMBODIMENTS

Therefore, an object of the present invention is to provide a handheld pointing device so that the corresponding host can avoid the aforementioned determination error.

The present invention provides a handheld pointing device, which includes a main body, an image sensing module, an acceleration sensing module and a processing circuit. The image sensing module is disposed in the main body and configured to capture an image containing at least one reference light source and accordingly generate an optical sensing signal. The acceleration sensing module is disposed in the main body and configured to sense an acceleration value in each one of two dimensions; wherein the acceleration sensing module outputs an acceleration sensing signal if an absolute value of the summation of the two acceleration values in two dimensions is located within a predetermined acceleration range. The processing circuit is configured to receive the optical sensing signal and the acceleration sensing signal and accordingly generate an output signal.

The present invention further provides a handheld pointing device, which includes a main body, an image sensing module, an acceleration sensing module and a processing circuit. The image sensing module is disposed in the main body and configured to capture an image containing at least one reference light source and accordingly generate an optical sensing signal indicating a coordinate position of the reference light source(s) in the captured image. The acceleration sensing module is disposed in the main body and configured to sense a first acceleration value, a second acceleration value and a third acceleration value respectively in three dimensions of a space where the main body locates, and generate, if an absolute value of the summation of the first, second and third acceleration values is located within a predetermined acceleration range, an acceleration sensing signal indicating a ratio of the first acceleration value to the second acceleration value. The processing circuit is configured to receive the optical sensing signal and the acceleration sensing signal and accordingly generate an output signal.

The present invention still further provides a handheld pointing device, which includes a main body, an image sensing module and a processing circuit. The main body has an axis direction along which a user holds the handheld pointing device. The image sensing module is disposed in the main body and configured to sense a reference light source having a pattern and capture an image containing the reference light source. The processing circuit, disposed in the main body and electrically connected to the image sensing module, is configured to receive the captured image containing the reference light source and calculate a rotation angle of the main body relative to the axis direction according to a rotation angle of the pattern in the captured image.

In summary, the handheld pointing device according to one embodiment of the present invention is disposed with an acceleration sensing module therein for sensing the acceleration values in at least two different dimensions. If the absolute value of the summation of the two sensed acceleration values is located within a predetermined acceleration range, the acceleration sensing module generates an acceleration sensing signal indicating a ratio of the two acceleration values. Therefore, when a user holds the handheld pointing device and rotates his/her wrist 180 degrees, the handheld pointing device in this embodiment can correct the coordinate position of the reference light source in the captured image according to the acceleration sensing signal. Consequently, the host can, according to the coordinate position corrected by the handheld pointing device, control an object (for example, a cursor) on a display screen of a display apparatus corresponding to the handheld pointing device without error occurring.

In addition, the handheld pointing device according to another embodiment of the present invention is configured to have an image sensing module for sensing a reference light source with a pattern, capturing an image containing a sub-image of the reference light source and accordingly calculating a rotation angle of a main body relative to an axis thereof according to a rotation angle of the pattern in the captured image. Therefore, when a user holds the handheld pointing device and rotates his/her wrist 180 degrees, the handheld pointing device in this embodiment can correct the coordinate position of the reference light source in the captured image according to the calculated rotation angle of the pattern in the captured image. Consequently, the host can, according to the coordinate position corrected by the handheld pointing device, control an object (for example, a cursor) on a display screen of a display apparatus corresponding to the handheld pointing device without error occurring.

### BRIEF DESCRIPTION OF THE DRAWINGS

The above embodiments will become more readily apparent to those ordinarily skilled in the art after reviewing the following detailed description and accompanying drawings, in which:

FIG. 1 is a schematic view illustrating a handheld pointing device rotating with a rotation of a user's wrist;

FIG. 2 is a schematic view of an exemplary captured image before the handheld pointing device shown in FIG. 1 being rotated;

FIG. 3 is a schematic view of an exemplary captured image after the handheld pointing device shown in FIG. 1 being rotated 180 degrees;

FIG. 4 is a schematic transparent view of a handheld pointing device in accordance with an embodiment of the present invention;

FIG. 5 is a schematic transparent view of a handheld pointing device in accordance with another embodiment of the present invention;

FIG. 6 is a schematic view of an exemplary pattern;

FIG. 7 is a schematic view illustrating the exemplary pattern shown in FIG. 6 after being rotated 180 degrees;

FIG. 8 is a schematic view of another exemplary pattern; and

FIG. 9 is a schematic view illustrating the exemplary pattern shown in FIG. 8 after being rotated 90 degrees.

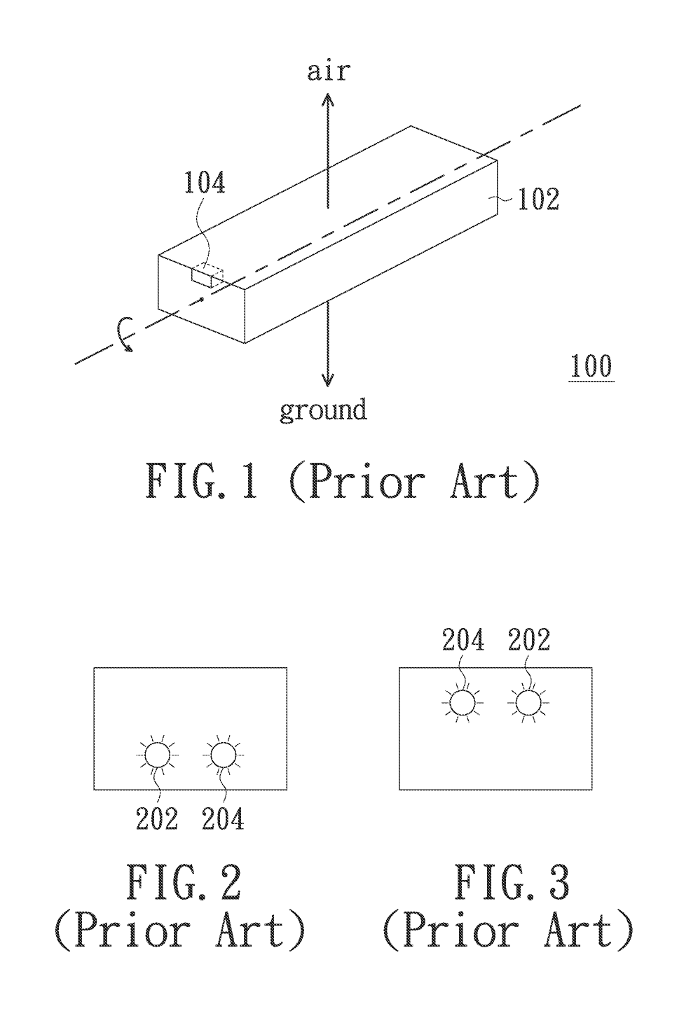

### DETAILED DESCRIPTION OF PREFERRED EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

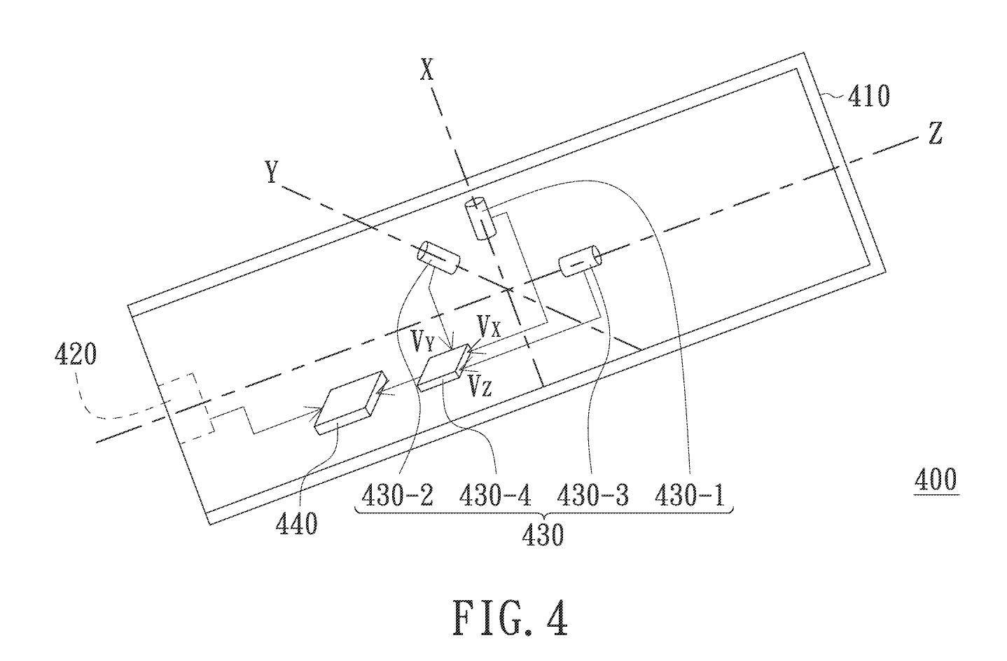

FIG. 4 is a schematic transparent view of a handheld pointing device in accordance with an embodiment of the present invention. As shown, the handheld pointing device 400 in this embodiment includes a main body 410, an image sensing module 420, an acceleration sensing module 430 and a processing circuit 440; wherein the image sensing module 420, the acceleration sensing module 430 and the processing circuit 440 are disposed in the main body 410. The image sensing module 420 is configured to capture an image, which contains a sub-image of at least one reference light source (e.g., an infrared diode emitting light), and accordingly generate an optical sensing signal indicting the coordinate position of the reference light source in the captured image.

The acceleration sensing module 430 is configured to sense acceleration values V_{X}, V_{Y} and V_{Z}, which are respectively referred to the acceleration values in three different dimensions (i.e., X-axis, Y-axis and Z-axis) of a space where the main body 410 locates. In this embodiment, the acceleration sensing module 430 includes three acceleration sensors 430-1, 430-2 and 430-3 and a control circuit 430-4. The acceleration sensors 430-1, 430-2 and 430-3 are configured to sense the acceleration values V_{X}, V_{Y} and V_{Z} and accordingly output the sensed acceleration values V_{X}, V_{Y} and V_{Z} to the control circuit 430-4, respectively. The control circuit 430-4 is configured to determine that |V_{X}+V_{Y}+V_{Z}| whether or not being located within a predetermined acceleration range (e.g., a gravitational unit (g)). Specifically, if |V_{X}+V_{y}+V_{Z}| is located within the predetermined acceleration range, the control circuit 430-4 is further configured to generate an acceleration sensing signal indicating a ratio of any two of the three acceleration values V_{X}, V_{Y} and V_{Z}, for example, a ratio of the acceleration value V_{X} to the acceleration value V_{Y}.

The images captured by the image sensing module 420 is set to have its long edge parallel to the X-axis and its shorter edge parallel to the Y-axis. Therefore, when a user holds and hovers the handheld pointing device 400 so as to make the acceleration sensor 430-2 have a sensing axis parallel to the gravity direction and the acceleration sensors 430-1, 430-3 each have a sensing axis perpendicular to the gravity direction, the acceleration value V_{Y} is either +g or -g and both of the acceleration values V_{X} and V_{Y} are zero. On the contrary, when a user holds and hovers the handheld pointing device 400 and rotates his/her wrist 180 degrees so as to make the image captured by the image sensing module 420 accordingly rotate 180 degrees and the acceleration sensor 430-2 have a sensing axis parallel to the gravity direction and the acceleration sensors 430-1, 430-3 each have a sensing axis perpendicular to the gravity direction, the acceleration value V_{Y} is either +g or −g and both of the acceleration values V_{X} and V_{Y} are zero.

As mentioned above, the control circuit 430-4 is configured to determine that |V_{X}+V_{Y}+V_{Z}| whether or not being located within a predetermined acceleration range. Specifically, the handheld pointing device 400 is determined to have a sudden movement caused by an external force if that |V_{X}+V_{Y}+V_{Z}| is not located within the predetermined acceleration range, and accordingly the control circuit 430-4 is configured not to output any signal. Alternatively, the control circuit 430-4 is configured to generate an acceleration sensing signal indicating a ratio of the acceleration value V_{X} to the acceleration value V_{Y} if that |V_{X}+V_{Y}+V_{Z}| is located within the predetermined acceleration range. Because the ratio of the acceleration value V_{X} to the acceleration value V_{Y} is indicated by the acceleration sensing signal, the processing circuit 440 can, after receiving the optical sensing signal and the acceleration sensing signal, determine the rotation angle of the main body 410 relative to the axis thereof according to the acceleration sensing signal, correct the coordinate position information carried in the optical sensing signal (i.e., correct the coordinate position of the reference light source in the captured image) according to the acceleration sensing signal and accordingly generate an output signal. Thus, a host (not shown) adapted to use with the handheld pointing device 400 can, according to the output signal, control an object (for example, a cursor) on a display screen of a display apparatus (not shown) corresponding to the handheld pointing device 400 without error occurring.

The correction process of the coordinate position information in optical sensing signal is described in the following; wherein the correction process is exemplified by employing one sensed reference light source only. Herein, the image captured by the image sensing module 420 is rectangular; the captured image has its long edge parallel to the sensing axis of the acceleration sensor 430-1 and its shorter edge parallel to the sensing axis of the acceleration sensor 430-2; and the intersection of the two sensing axes is located at the upper-left corner of the captured image. Thus, the coordinate position of the reference light source in the captured images indicated by the optical sensing signal can be corrected by the following six equations:

X′=X−ImageWidth/2 (1)

Y′=Y−ImageHeight/2 (2)

X″=X′cosθ+Y′sinθ (3)

Y″=−X′sinθ+Y′cosθ (4)

X′″=X″+ImageWidth/2 (5)

Y′″=Y″+ImageHeight/2 (6)

where X, X′, X″ and X″″ each indicate the position of the reference light source on X-axis; Y, Y′, Y″ and Y′″ each indicate the position of the reference light source on Y-axis; X is the position of the reference light source on X-axis directly derived from the optical sensing signal; Y is the position of the reference light source on Y-axis directly derived from the optical sensing signal; X″′ is the position of the reference light source on X-axis after being corrected; Y″′ is the position of the reference light source on Y-axis after being corrected; ImageWidth indicates the width of the captured image (i.e., the length of the long edge of the captured image); ImageHeight indicates the height of the captured image (i.e., the length of the shorter edge of the captured image). Additionally, cos♭=|V_{y}|/|g_{xy}|, sinθ=|Vₓ|/|g_{xy}|·|g_{xy}|=\sqrt{Vₓ²+V_{y}²}, wherein V_{X} is an acceleration value sensed by the acceleration sensor 430-1, V_{Y} is an acceleration value sensed by the acceleration sensor 430-2, and g_{xy} is the gravity calculated according to the acceleration values V_{X}, V_{Y}.

According to the above description, it is understood that the acceleration sensing module employed in the handheld pointing device of the present invention can be configured to sense the acceleration values in two different dimensions only (for example, the two acceleration values V_{X}, V_{Y}). Accordingly, the acceleration sensing module is configured to generate an acceleration sensing signal indicating a ratio of the acceleration value V_{X} to the acceleration value V_{Y} if that |V_{X}+V_{Y}| is located within a predetermined acceleration range. In addition, the aforementioned handheld pointing devices each can also be used with one single reference source only.

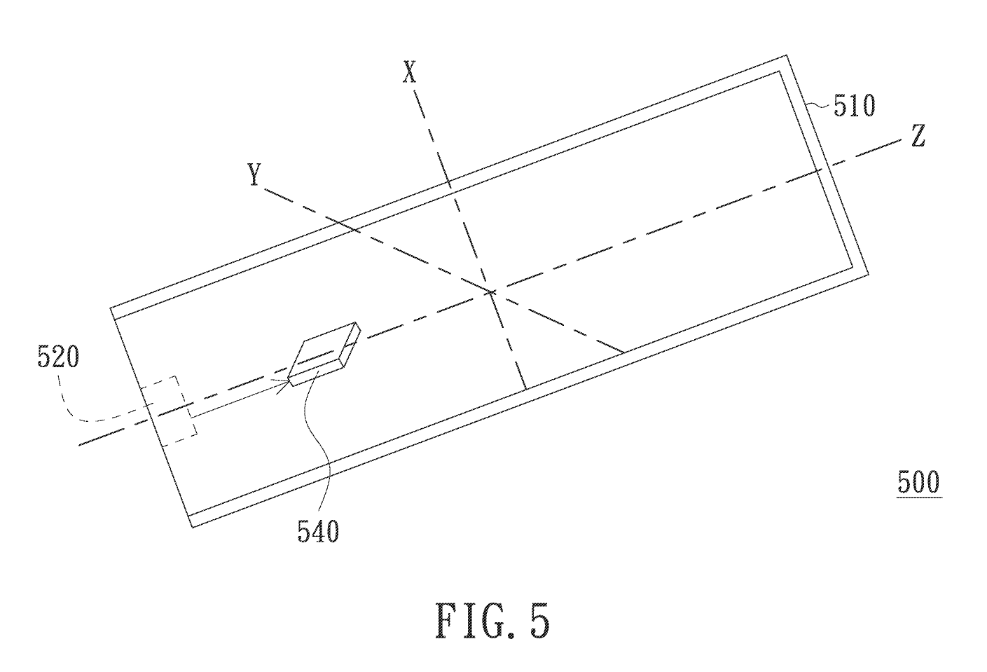

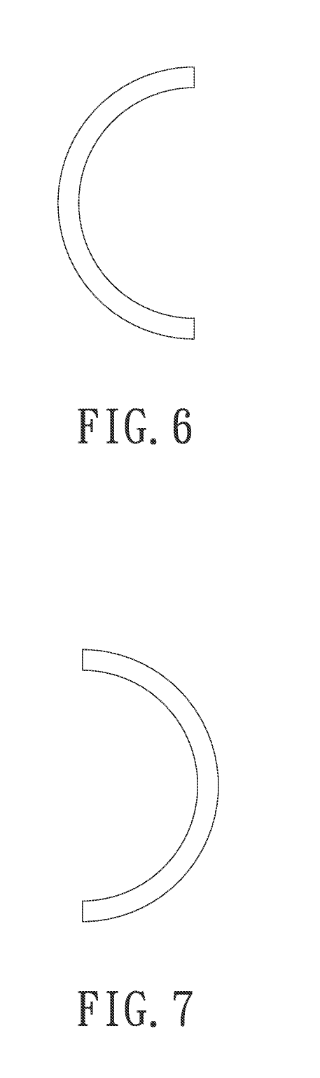

FIG. 5 is a schematic transparent view of a handheld pointing device in accordance with another embodiment of the present invention. As shown, the handheld pointing device 500 in this embodiment includes a main body 510, an image sensing module 520 and a processing circuit 540; wherein the image sensing module 520 and the processing circuit 540 are disposed in the main body 510. The main body 510 has an axial direction (i.e., Z-axis), and along which a user holds the handheld pointing device 500. The image sensing module 520 is configured to sense a reference light source with a pattern, capture an image containing a sub-image of the reference light source and accordingly generate an optical sensing signal indicating the coordinate position of the reference light source in the captured image; wherein one exemplarily pattern is illustrated in FIG. 6. The processing circuit 540, electrically connected to the image sensing module 520, is configured to obtain the aforementioned captured image containing the sub-image of the reference light source and the optical sensing signal and calculate a rotational angle of the main body 510 relative to the axial direction (i.e., Z-axis) according to the rotation angle of the pattern in the captured image. FIG. 7 is a schematic view illustrating the pattern shown in FIG. 6 after being rotated 180 degrees.

Therefore, when a user holds the handheld pointing device 500 and rotates his/her wrist 180 degrees, the processing circuit 540 can correct the coordinate position of the reference light source in the captured image according to the rotation angle of the pattern shown in FIGS. 6, 7 in the captured image. Consequently, the host (not shown) can, according to the coordinate position corrected by the handheld pointing device 500, control an object (for example, a cursor) on a display screen of a display apparatus (not shown) corresponding to the handheld pointing device 500 without error occurring.

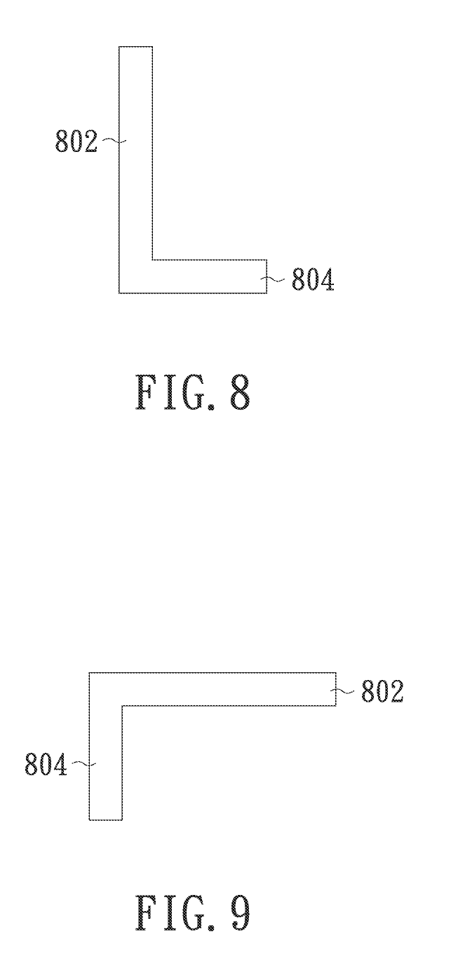

FIG. 8 is a schematic view illustrating another exemplary pattern of a reference light source, and FIG. 9 is a schematic view illustrating the pattern shown in FIG. 8 after being rotated 90 degrees. As shown, when a user holds the handheld pointing device 500 and rotates his/her wrist 90 degrees, the processing circuit 540 can correct the coordinate position of the reference light source in the captured image according to the rotation angle of the pattern in the captured image. For example, the processing circuit 540 can determine the rotation angle of the L-shaped pattern in the captured image according to the relative positions of the long edge 802 and the shorter edge 804 thereof depicted in FIGS. 8, 9.

In addition, it is to be noted that each one of the reference light sources can be realized by one light emitting element, a plurality of light emitting elements, one reflective element or a plurality of reflective elements. In the case of the reference light source being realized by one light emitting element, the light emitting element is configured to have a predetermined pattern, as exemplarily illustrated in FIGS. 6. 8, on a light emission surface thereof In the case of the reference light source being realized by a plurality of light emitting elements, these light emitting elements are arranged to corporately form a predetermined pattern. In the case of the reference light source being realized by one reflective element, the reflective element is configured to have a predetermined pattern on a reflective surface thereof In addition, it is understood that the reflective surface is configured to reflect light within a specific wavelength band (e.g., infrared light) only; and the infrared light is provided from an external light source which is for example, disposed on a remote controller. In the case of the reference light source being realized by a plurality of reflective elements, these reflective elements are arranged to corporately form a predetermined pattern. Likewise, the reflective elements are configured to reflect light within a specific wavelength band.

In summary, the handheld pointing device according to one embodiment of the present invention is disposed with an acceleration sensing module therein for sensing the acceleration values in at least two different dimensions. If the absolute value of the summation of the two sensed acceleration values is located within a predetermined acceleration range, the acceleration sensing module generates an acceleration sensing signal indicating a ratio of the two acceleration values. Therefore, when a user holds the handheld pointing device and rotates his/her wrist 180 degrees, the handheld pointing device in this embodiment can correct the coordinate position of the reference light source in the captured image according to the acceleration sensing signal. Consequently, the host can, according to the coordinate position corrected by the handheld pointing device, control an object (for example, a cursor) on a display screen of a display apparatus corresponding to the handheld pointing device without error occurring.

In addition, the handheld pointing device according to another embodiment of the present invention is configured to have an image sensing module for sensing a reference light source with a pattern, capturing an image containing a sub-image of the reference light source and accordingly calculating a rotation angle of a main body relative to an axis thereof according to a rotation angle of the pattern in the captured image. Therefore, when a user holds the handheld pointing device and rotates his/her wrist 180 degrees, the handheld pointing device in this embodiment can correct the coordinate position of the reference light source in the captured image according to the calculated rotation angle of the pattern in the captured image. Consequently, the host can, according to the coordinate position corrected by the handheld pointing device, control an object (for example, a cursor) on a display screen of a display apparatus corresponding to the handheld pointing device without error occurring.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A handheld pointing device, comprising:
a main body;
an image sensing module disposed in the main body and configured to capture an image comprising at least one reference light source and accordingly generate an optical sensing signal;
an acceleration sensing module disposed in the main body and configured to sense an acceleration value in each one of two dimensions, wherein the acceleration sensing module outputs an acceleration sensing signal if an absolute value of the summation of the two acceleration values in two dimensions is located within a predetermined acceleration range; and
a processing circuit configured to receive the optical sensing signal and the acceleration sensing signal and accordingly generate an output signal.

2. The handheld pointing device according to claim 1, wherein the acceleration sensing signal indicates a ratio of the two acceleration values in the two dimensions.

3. The handheld pointing device according to claim 1, wherein the predetermined acceleration range comprises a gravitational unit.

4. A handheld pointing device, comprising:
a main body;
an image sensing module disposed in the main body and configured to capture an image comprising at least one reference light source and accordingly generate an optical sensing signal indicating a coordinate position of the reference light source(s) in the captured image;
an acceleration sensing module disposed in the main body and configured to sense a first acceleration value, a second acceleration value and a third acceleration value respectively in three dimensions of a space where the main body is, and generate, if an absolute value of the summation of the first, second and third acceleration values is located within a predetermined acceleration range, an acceleration sensing signal indicating a ratio of the first acceleration value to the second acceleration value; and
a processing circuit configured to receive the optical sensing signal and the acceleration sensing signal and accordingly generate an output signal.

5. The handheld pointing device according to claim 4, wherein the predetermined acceleration range comprises a gravitational unit.

6. A handheld pointing device, comprising:
a main body having an axis direction along which a user holds the handheld pointing device;
an image sensing module disposed in the main body and configured to sense a reference light source having a pattern and capture an image comprising the reference light source; and
a processing circuit, disposed in the main body and electrically connected to the image sensing module, configured to receive the captured image comprising the reference light source and calculate a rotation angle of the main body relative to the axis direction according to a rotation angle of the pattern in the captured image.

7. The handheld pointing device according to claim 6, wherein the reference light source comprises a light emitting element configured to have the pattern on a light emission surface thereof.

8. The handheld pointing device according to claim 6, wherein the reference light source comprises a plurality of light emitting elements arranged to corporately form the pattern.

9. The handheld pointing device according to claim 6, wherein the reference light source comprises a reflective element configured to have the pattern on a reflective surface thereof.

10. The handheld pointing device according to claim 9, wherein the reflective surface is configured to reflect light within a specific wavelength band.

11. The handheld pointing device according to claim 10, wherein the reference light source comprises a plurality of reflective elements arranged to corporately form the pattern.

12. The handheld pointing device according to claim 9, wherein the reflective surfaces are configured to reflect light within a specific wavelength band.
